(19) United States
(12) Patent Application Publication
(10) Pub. No.: US 2012/0225236 A1
(43) Pub. Date: Sep. 6, 2012

(54) Composite Building Panel and Method

(76) Inventor: James Edward Cox, Pemberton, NJ (US)

(21) Appl. No.: 13/407,129

(22) Filed: Feb. 28, 2012

Related U.S. Application Data
(60) Provisional application No. 61/464,364, filed on Mar. 3, 2011.

(51) Int. Cl. E04B 1/74; B32B 27/08; B32B 5/18

(52) U.S. Cl. 428/54; 428/58; 428/71

(57) ABSTRACT

An insulated building panel and building construction panel system utilizes a plurality of panels made of solid foam core with insulation R values, encapsulated within external hard coatings permanently bonded to the cores. The cores optimally consist of expanded polystyrene foam and the hard coatings are a polyurethane hard coat blend. Roof and exterior wall construction units utilize a plurality of adjacently aligned panels, each panel being located between support members and being compressed together and pressure-fitted against adjacent panels and support members such that each construction unit is formed from the compressed, pressure-fitted panels. The panels themselves serve as the primary structural elements and only insulating elements of the construction units.

This application claims the benefit of provisional utility application Ser. No. 61/464,364 filed on Mar. 3, 2011.

### BACKGROUND OF THE INVENTION

Fiberglass is currently utilized as the insulation of choice in the construction of roofs and exterior walls of pre-engineered. buildings. This insulation is commonly installed over support members like wall girts and purlins, both z and c shaped. Where higher insulation R values are required, mainly in the roof areas, fiberglass must be run between the purlins and then criss-crossed over the top of the purlins to get additional thickness, in order to achieve the needed R values. Where such insulation crosses the girts and purlins, it is squeezed so tight it reduces the thermal break so that there can be heat conduction between the exterior wall or roof sheathing and the support members. This creates a direct path for heat to travel into a building through these support members. This heat radiates into the interior of the buildings. Heat can also radiate out of the building the same way.

There are other disadvantages of utilizing fiberglass insulation. For instance, fiberglass is irritating to the skin and once it gets into the lungs, can cause bleeding and other serious health conditions. As a result, increased care, including the use of masks, long sleeve shirts, and gloves, must be worn during fiberglass installation.

In addition, the facing on fiberglass is easily ripped and torn. This allows moisture into the insulation, breaking the vapor barrier and placing a hole in the building envelope, thereby significantly cutting the R value. Fiberglass also can grow mold when wet and has a had appearance, even when patched. Though the facing of fiberglass may stay exposed on the interior, it is not very washable and, depending on the quality, may become brittle over time. Further, rolls of fiberglass are often awkward to work with because of their wide width and long lengths. They do not store well on the jobsite and are subject to being damaged even before they are installed.

Moreover, installation of fiberglass can be labor intensive, especially in winds, and must be covered with siding or roofing as it is installed for its protection. Installed fiberglass has nothing to protect its integrity on its own after its installation. Standard fiberglass systems will not support a person who unintentionally steps or falls in it, thereby creating a risk of severe injury or, if the fall is high enough, death. While there are a number of fall arrest systems on the market to address safety concerns when installing fiberglass, such fall protection systems are labor intensive and costly to purchase and set up.

Thus, fiberglass fundamentally does not fully address the heat loss or gain by conduction, convection, or radiation and it is difficult to store, install safely, and maintain. Very significantly, fiberglass adds no strength to the constructed roof or exterior wall itself.

There are many alternative insulation construction mediums on the market such as bubble wrap, micro-bubble, and thin polystyrene rolled sheets with aluminum or white vinyl facings acting as a radiant barrier. However, these products are mainly for agricultural uses, small buildings, or utilized where lesser R values are required.

Different rigid foams such as polyurethane, polyisobutylene, and polyisocyanurate, use many of the same facings, including aluminum, and have superior R values to fiberglass, but these are very expensive and may give off gas and lose R value over time. in fact, certain of these foams are deadly when breathed in during a fire and may even be the cause of fires. Some must be sprayed on and most are not utilized as stand alone products. They must be covered with sheetrock or some other surface approved for direct exposure on the interior for their protection. And, again, none add strength to the building construction itself.

In summary, each of the alternative products described above do certain things well, but each falls short in other areas, including availability, high cost, labor intensiveness, the need for special equipment, structural support, and safety.

Thus, there are no insulation construction systems which address all the practical, economical, functional, versatility, and environmentally-friendly concerns required of an insulation system, while also providing structural value and strength to roof and exterior wall units which require effective insulation.

### SUMMARY OF THE INVENTION

It is thus the object of the present invention to provide an insulated composite building panel and panel construction system which overcomes the limitations and disadvantages of existing pre-engineered building insulation, along with its building envelope, and construction systems for roofs and exterior wall units.

It is the object of the present invention to provide an insulated building panel and building construction panel system which utilizes a plurality of panels made of solid foam core with insulation R values, encapsulated within external hard coatings permanently bonded to the cores. The cores optimally consist of expanded polystyrene foam and the hard coatings are a polyurethane hard coat blend. Roof and exterior wall construction units utilize a plurality of adjacently aligned panels, each panel being located between support members and being compressed together and pressure-fitted against adjacent panels and support members such that each construction unit is formed from the compressed, pressure-fitted panels. The panels themselves serve as the primary structural elements, i.e. solid blocking to the girt and purlin support members, and only insulating elements of the construction units.

The panels and panel system of the present invention result in many benefits and advantages, including, but not limited to, the following:

The panels compromise a rigid foam core with R values sufficient to provide the requisite building insulation.

The panel coating comprises a hard coat with very high impact resistance. It will not tear, is impervious to water absorption and has an ASTM E-84 fire rating for interior and exterior uses when its fire restive coating is added. It can have a fire retardant built into the foam core as well. The hard coating can accept heat in excess of 250° F. with no adverse affects, will not promote mold growth, resist attack by vermin, and can be left exposed on the interior with no other protective covering such as sheetrock. In addition, the coating will not smoke excessively if heated and any residue is not deadly if breathed. The coating can also be high pressure washed without incurring damage.

Each panel is very lightweight, normally weighing less than twenty pounds per panel. As a result, the panels are easily lifted and carried by installers. In addition, because of their lightweight, shipping costs of panels are reduced.

The panels are virtually incompressible, thus eliminating the reduction of the thermal barriers created by the panels.

The panels will not lose insulation R value over time.

The panels are economically manufactured with readily available materials, since there are only two major components in each panel.

Panels can be made from 100% recyclable materials.

Panels in the roof and exterior wall construction system can be installed easily and safely, without risk or hazard to workers.

Installation of the panels in the construction system can be performed without the use of special breathing equipment, since the panels do not expel harmful vapors or gas during or after installation.

Panels in the construction system need no special equipment to install, They can be installed in all environments, including in wind. They can be field altered and installed from roof eaves towards roof peaks completely, before roofing or as the roofing is being installed. Panels can also be installed from base to cave or gable completely before siding is installed or while panels are being installed.

The panel construction system can be employed as the exterior vapor barriers of the roof and wall units since there are no unsealed joints completing the building's envelope.

The panel construction system will contribute to sound deadening and can be used for cold storage and food processing areas.

The panel construction system eliminates many otherwise required support members, such as purlins and girt bracing and barring plates under roof clips on standing-seam roofs as the panel is considered solid blocking.

The novel features Which are considered as characteristic of the invention are set forth in particular in the appended claims. The invention, itself, however, both as to its design, construction ruction and use, together with additional features and advantages thereof, are best understood upon review of the following detailed description with reference to the accompanying drawings.

### BRIEF DESCRIPTION OF THE DRAWINGS

FIG. 1 is a partial cross-section of a building structure showing the insulated construction panels and panel system utilized in roof and exterior wall construction units.

FIG. 2 is a perspective view of a typical roof panel of the present invention, showing a section broken away.

FIG. 3 is a detailed view of the broken away section shown in FIG. 2.

FIG. 4 is a perspective view of a typical roof peak panel of the present invention,

FIG. 5 is a joint cross-section of a mid-span connection of two panels of the present invention.

FIG. 6 is a joint cross-section showing the connection of a peak panel and roof panel of the present invention.

### DETAILED DESCRIPTION OF THE INVENTION

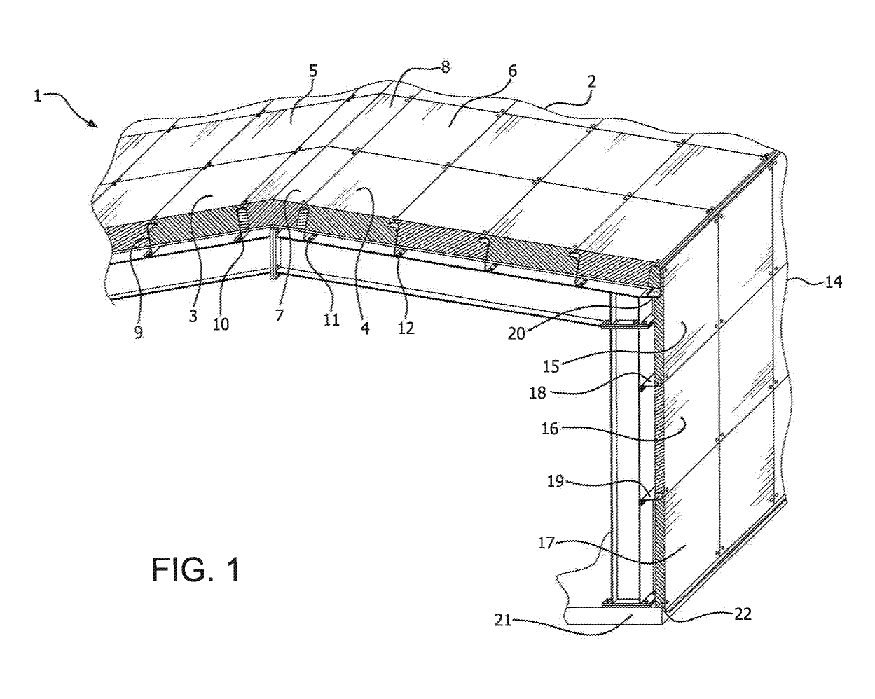

The components of roof and exterior wall construction system 1 of the present invention are most clearly shown in FIG. 1, a partial cross-sectional representation of a roof construction unit and attached exterior wall construction unit of a building. Roof construction unit 2 comprises a plurality of foam encapsulated roof panels adjacently aligned. Roof panels 3, 4, 5 and 6 are referenced in FIG. 1, which also shows additional roof panels which comprise roof construction unit 2. Roof panels 7 and 8 are roof peak panels. Each panel is fitted between roof purlins or like support members, e.g. 9, 10, 11, and 12 which extend substantially the length of roof construction unit 2. Each roof panel, including the roof peak panels, is custom designed and manufactured to be fitted within an adjacent purlin and compressed together and pressure-fitted against adjacent panels and purlins to form uniform roof construction unit 2.

In like manner, exterior wall construction unit 14 comprises a plurality of foam encapsulated wall panels adjacently aligned. Wall panels 15, 16, and 17 are referenced in FIG, I, which also shows additional wall panels, which comprise wall construction unit 14. Each panel is fitted between girls or like support members 18 and 19 which extend substantially the length of wall construction unit 14. Eave purlin or strut 20 is utilized in the joint connection between roof construction unit 2 and wall construction unit 14. The bottom of wall construction unit 14 is attached to the building's concrete slab 21 by base trim support and support base support angle members 22. As described previously with regard to the roof panels, each of the wall panels is custom designed and manufactured to be fitted within adjacent purlins and compressed together and pressure-fitted against adjacent panels and purlins to form uniform wall construction unit 14.

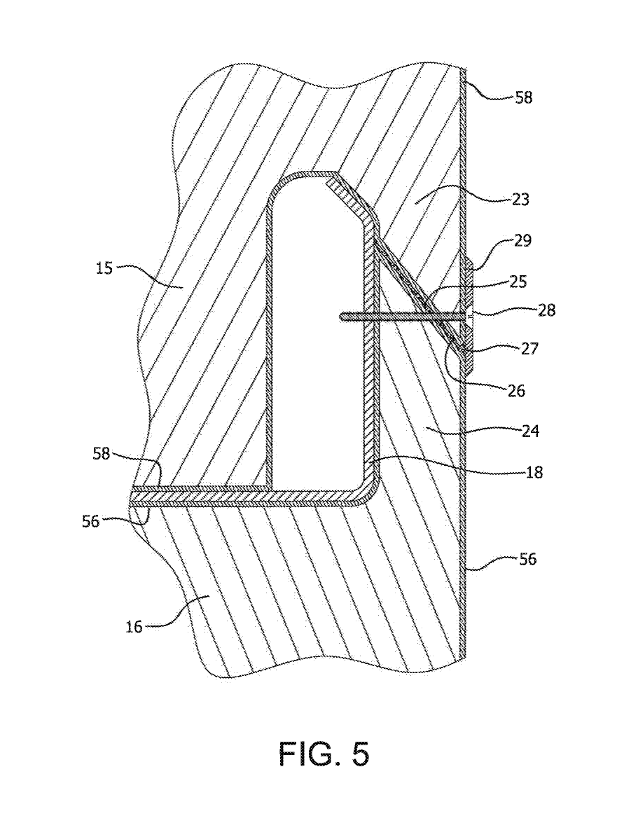

FIG. 5 is a representative cross-section detailing the joint connection between adjacent roof panels and between adjacent wall panels. Adjacent panels, here wall panels 15 and 16, are formed to fit precisely over girt 18. The panels are configured with thermal break sections 23 and 24. Form fitting panels on the other adjacent slides of panels 15 and 16 compress these panels against each other and girt 18, such that the panels are pressure-fitted in position.

Panels 15 and 16 are diagonally cut such that they mate at tapered surfaces 25 and 26. Polyurethane adhesive sealant 27 is feed between tapered surfaces 25 and 26 to provide a further tight connection between panels 15 and 16. Screw 28 extending through washer 29 can optionally be inserted through thermal break sections 23 and 24 of panels 15 and 16, as an additional connection means, although in most instances, this would be unnecessary.

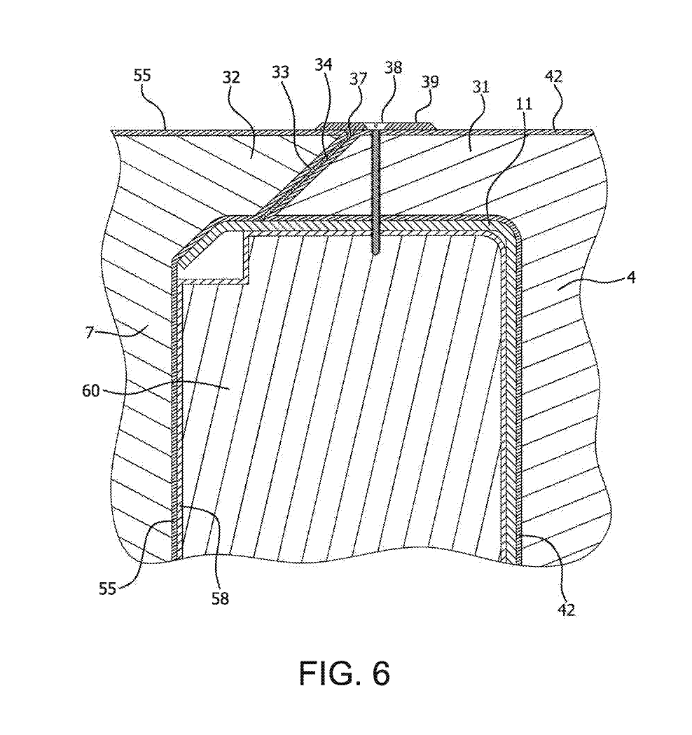

FIG. 6 is a representative cross-section detailing the roof peak joint connection with adjacent panels. Roof panel 4 and roof peak. panel 7 are again formed to fit precisely over roof purlin 11. These panels are configured with thermal break sections 31 and 32. Form fitting panels on the other adjacent sides of panels 4 and 7 compress these panels against roof purlin 11 such that the panels are pressure-fitted in position. As has been described previously with regard to the wall panel joint connection, panels 4 and 7 are diagonally cut such that they mate at tapered surfaces 33 and 34. Polyurethane adhesive sealant 37 is feed between tapered surfaces 33 and 34 to provide a further tight connection between panels 4 and 7. Screw 38 extending through washer 39 can optionally be inserted through thermal break sections 31 and 32 of panels 4 and 7, as an additional connection means, although in most instances, this would be unnecessary. Foam filler block 60 is inserted within the interior of roof purlin 11, to complete the joint.

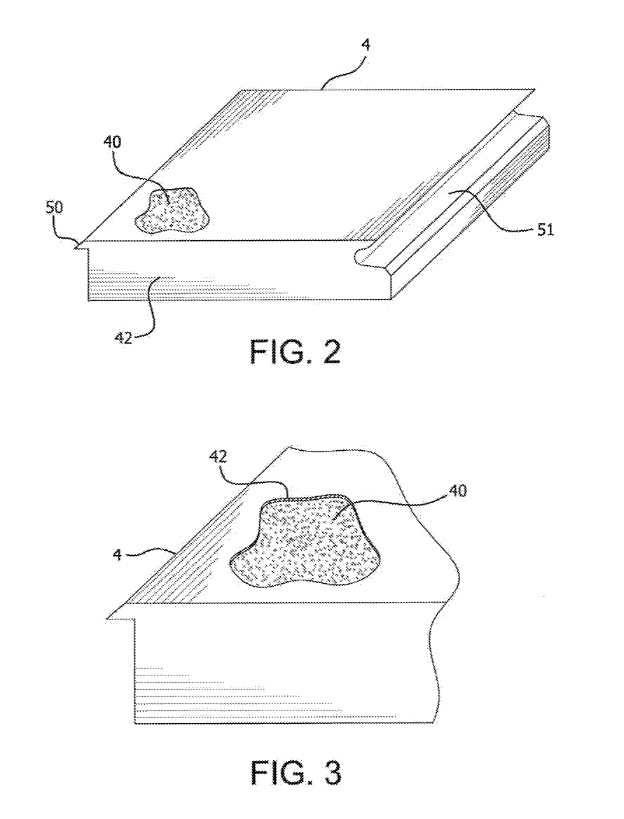

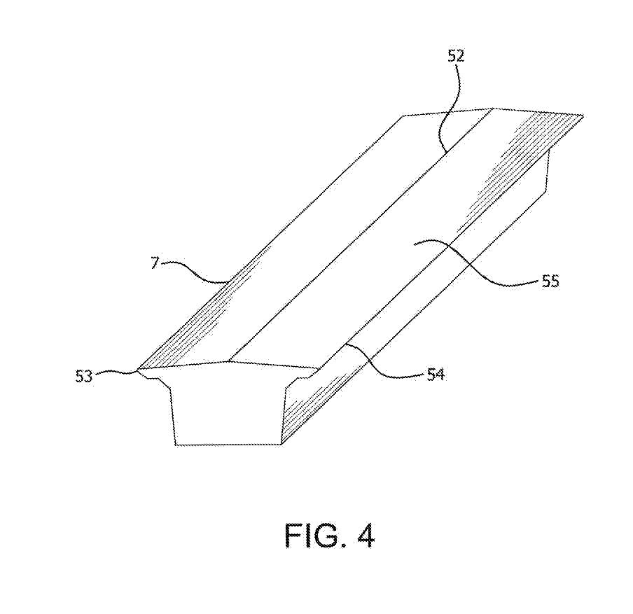

FIGS. 2 and 3 show a representative roof panel and FIG. 4 shows a representative roof peak panel. Both the roof and roof peak panels, as well as the wall panels shown in FIG. 1, are identical in construction. The sole difference among the panels is their configurations and how they are custom cut to fit with adjacent panels in the system. For instance, roof panel 3 is configured such that its sides 50 and 51 mate precisely with adjacent panels and purlins. Similarly, sides 53 and 54 of roof peak panel 7, with its peak 52, are cut to mate with adjacent roof panels.

As best seen in FIG. 2, roof panel 3, as with all the panels in the system, comprises rigid foam core 40 comprising a lightweight, rigid, closed cell material. It is contemplated that expanded polystyrene (EPS) foam would optimally be used. Equivalent foams such as polyisocyanurate, phenolic, polyurethane or polystyrene could also be utilized. The rigid foam used in the panels must have a certain rated R insulated value as specified by the system designer and code requirements. R is commonly used as the measurement of the resistance to heat flow. For instance, R4 is the heat resistance value of a one inch thick section of one pound density foam. The foam employed in the panels of the present invention optimally have an insulation value between R4 and R4.55, but values in excess of R4.55 are contemplated as well.

Each panel, be they roof panel 4, roof peak panel 7, or a wall panel, is fully encapsulated, as seen in FIGS. 2 and 3, by coating 42 comprising a polyurethane hard coat blend permanently bonded to foam core 40. FIG, 4 shows roof panel 7 having identically composed coating 55. Wall panels 15 and 16 in FIG. 5 have identical coatings 56 and 57. And filler block 60 in FIG. 6 has identical coating 58. The coating used on the panels and filler blocks have the following characteristics:

1. The coating has a Shore D hardness factor above 60, based on the standard Shore hardness measurement system.

2. The coating has a tensile strength in excess of 2500 psi, tensile strength being measured as the maximum stress that a material can withstand while being stretched before material failure.

3. The coating has an elongation strength of 20% or higher—elongation strength being defined as the percentage increase in length of a material which occurs before it breaks down under tension. The combination of high elongation strength and high tensile strength results in a material of extreme toughness.

4. The coating is rigid or stiff. This stiffness, or flexural modulus, is measured by pounds per square inch. The coating has a flexural modulus of 50,000 psi.

5. The coating has an impact strength, the resistance of the coating to withstand a suddenly applied load—expressed in terms of energy, in excess of 50 pounds per inch.

Fire coating can be applied to all the panels in construction system 1, and may be required by specification if the panels are installed without a fire protective barrier. There are roof and wall designs, however, that provide for barriers and, in such cases, no fire coating is needed.

Each panel in construction system 1 is identical in its hard coating, encapsulated foam construction. Each can withstand high impact and compressive loads and each provides insulation characteristics which meet or exceed those resulting from the use of fiberglass or similar insulation material. While siding or roof shingles or other roof and wall coverings can be added to assembled panels, these are not necessary for the structural integrity of the system. The compressed, pressure-fitted panels of the roof and exterior wall construction units, as shown in FIG. 1 and as described, form integral, structurally sound, insulated, weatherproof building structures. Significantly, the panels themselves comprise the primary structural elements, i.e. solid blocking to the girt and purlin support members, and the only insulating elements of the roof and exterior wall construction units.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may he made without departing from the spirit of the invention.

1. A system for the construction of roof and exterior wall units, each said roof and wall unit comprising:
a plurality of adjacently aligned panels, each panel comprising a rigid foam core having an R insulation value and being encapsulated within an external hard coating permanently bonded to the core, the coating comprising a polyurethane hard coat blend, each panel being compressed together and pressure fitted against adjacent panels, whereby the unit is formed substantially from the plurality of compressed, pressure fitted panels, the panels serving as the primary structural elements and only insulating elements of the unit.

2. The system as in claim 1 wherein the panel core comprises rigid foam having an insulation value of R4 or above.

3. The system as in claim 1 wherein the coating comprises a polyurethane hard coat blend having a Shore D hardness factor above 60.

4. The system as in claim 1 wherein the core comprises expanded polystyrene foam.

5. The system as in claim 3 wherein the coating comprises a tensile strength in excess of 2500 psi, an impact strength in excess of 50 pounds per inch, a flexural modulus of 50,000 psi, and an elongation strength of 20% or higher.

6. The system as in claim 2 wherein the coating comprises a polyurethane hard coat blend having a shore D hardness factor above 60.

7. The system as in claim 6 wherein the coating comprises a tensile strength in excess of 2500 psi, an impact strength in excess of 50 pounds per inch, a flexural modulus of 50,000 psi, and an elongation strength of at least 20%.

8. The system as in claim 1 further comprising a plurality of support members extending substantially the length of the unit, each panel being located between two support members and being compressed together and pressure-fitted against the support members.

9. The system as in claim 8 wherein the panel core comprises rigid foam having an insulation value of R4 or above.

10. The system as in claim 8 wherein the coating comprises a polyurethane hard coat blend having a Shore D hardness factor above 60.

11. The system as in claim 8 wherein the core comprises expanded polystyrene foam.

12. The system as in claim 10 wherein the coating comprises a tensile strength in excess of 2500 psi, an impact strength in excess of 50 pounds per inch, a flexural modulus of 50,000 psi, and an elongation strength of 20% or higher.

13. The system as in claim 9 wherein the coating comprises a polyurethane hard coat blend having a shore D hardness factor above 60.

14. The system as in claim 13 wherein the coating comprises a tensile strength in excess of 2500 psi, an impact strength in excess of 50 pounds per inch, a flexural modulus of 50,000 psi, and an elongation strength of at least 20%.

15. An insulated construction panel for roofs and exterior wall units, said panel comprising:
a panel core comprising rigid foam having an insulation value of R4 or above, said panel being encapsulated within an external hard coating permanently bonded to the core, the coating comprising a polyurethane hard coat blend having a shore D hardness factor above 60, whereby the panel serves as the primary structural element and only insulating element of a roof and exterior wall units.

16. The insulated construction panel as in claim 15 wherein the core comprises expanded polystyrene foam.

17. The insulated construction panel as in claim 15 wherein the coating comprises a tensile strength in excess of 2500 psi, an impact strength in excess of 50 pounds per inch, a flexural modulus of 50,000 psi, and an elongation strength of at least 20%.
